(19) United States
(12) Patent Application Publication
(10) Pub. No.: US 2007/0226519 A1
(43) Pub. Date: Sep. 27, 2007

(54) System, method, and computer-readable medium for controlling data flow in a network

(75) Inventor: Christopher R. Elbring, St. Louis, MO (US)

Correspondence Address: CROWELL & MORING LLP;INTELLECTUAL PROPERTY GROUP, P.O. BOX 14300, WASHINGTON, DC, 20044-4300, US

(73) Assignee: LOWER LEVEL SOFTWARE LLC, St. Louis, MO (US)

(21) Appl. No.: 11/385,740

(22) Filed: Mar. 22, 2006

(51) Int. Cl. H04N 7/16; H04L 9/32; H04L 9/00; G06F 12/14; G06F 17/30; G06F 11/30; G06F 7/04; G06K 9/00; H03M 1/68; H04K 1/00

(52) U.S. Cl. 713/190; 726/26; 726/27; 713/167

(57) ABSTRACT

A system, method and computer-readable medium for controlling writing of files in endpoint devices in a network are provided. In the system, a request to write a file at an endpoint of a network is intercepted and compared to predetermined criteria. If the file write request does not match any of the predetermined criteria the file write request is allowed to complete. If the file write request matches any of the predetermined criteria, a copy of the file is created and transmitted to a third party device, and at least temporarily the file write request is prevented from completing.

### BACKGROUND OF THE INVENTION

The present invention relates to the control of the writing of files in a network. More particularly, the present invention relates to a system, method and computer-readable medium for controlling file writing at endpoints of a network.

Currently, network administrators do not control what files are written to and from endpoint devices (endpoints), e.g., computers, laptops, etc., on their networks. There is no manner by which to control data flow to/from the endpoints. Although endpoint management devices exist, generally, they control ports, but do not control the file-writing process itself.

Also, most network attached storage (NAS) products are unaware of any files that may have been offloaded from an endpoint prior to the batch process. NAS utilizes a batch process and is only capable of looking at files resident on hard drives. Other NAS products that do not use a batch process take copies of files at specific intervals and compare them to files that were previously copied and archived. Neither NAS process knows which files were removed from an endpoint device.

Current security appliance products generally do not interact directly with endpoints of a network. The functionality of security appliance products tends to be processor heavy, which limits the ability to run the processes at the endpoints. Thus, security appliance products generally sit at central aggregation points and review TCP/IP data flow over a network, especially egress from/ingress to an internal network. These security appliance products look for signatures, anomalies, content, etc. that the network wants to control; however, the security appliances do not have the ability to perform their purpose-built tasks on or control egress from/ingress to endpoints.

### SUMMARY OF THE INVENTION

The present invention provides a system, method, and computer-readable medium for controlling file writing in a network. In accordance with exemplary embodiments of the present invention, a file write request at an endpoint of a network is interrupted before a file is transferred to a media device; the file is compared to predetermined criteria; if the file does not match any of the predetermined criteria, the file write request is allowed to be completed; and if the file matches any of the predetermined criteria, a copy of the file is created and transmitted to a third-party device, e.g., a server, for further processing, while preventing completion of the file write request.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates an exemplary embodiment of a system in accordance with the present invention;

FIG. 2 illustrates an exemplary embodiment of a third party device in accordance with the present invention;

FIG. 3 illustrates an exemplary embodiment of a client in accordance with the present invention;

FIG. 4 illustrates an exemplary embodiment of an intercept filter driver in accordance with the present invention;

FIG. 5 illustrates an exemplary embodiment of a redirector filter driver in accordance with the present invention;

FIG. 6 illustrates an exemplary embodiment of an encryption filter driver in accordance with the present invention;

FIG. 7 illustrates an exemplary embodiment of a method for controlling file writing in accordance with the present invention;

FIG. 8 illustrates another exemplary embodiment of a method for controlling file writing in accordance with the present invention;

FIG. 9 illustrates an exemplary embodiment of method for interacting with a client by a third party device, in accordance with the present invention;

FIG. 10 illustrates an exemplary embodiment of a criteria file in accordance with the present invention;

FIG. 11 illustrates an exemplary embodiment of a method for controlling writing of files, in accordance with the present invention;

FIG. 12 illustrates another exemplary embodiment of a method for controlling writing of files, in accordance with the present invention;

FIG. 13 illustrates an exemplary embodiment of a method for controlling writing of files using a pre-processing application, in accordance with the present invention; and

FIG. 14 illustrates another exemplary embodiment of a method for controlling writing of files using a pre-processing application, in accordance with the present invention.

### DETAILED DESCRIPTION OF THE EXEMPLARY EMBODIMENTS

The exemplary embodiments of the present invention allow network administrators and others to define parameters for allowing and disallowing file writing, thereby controlling the flow of data on and off network endpoint devices. Also, files that are requested to be written may be copied for backup and auditing purposes. In exemplary embodiments of the present invention, networks could control the flow of data on and off network endpoint devices in real time.

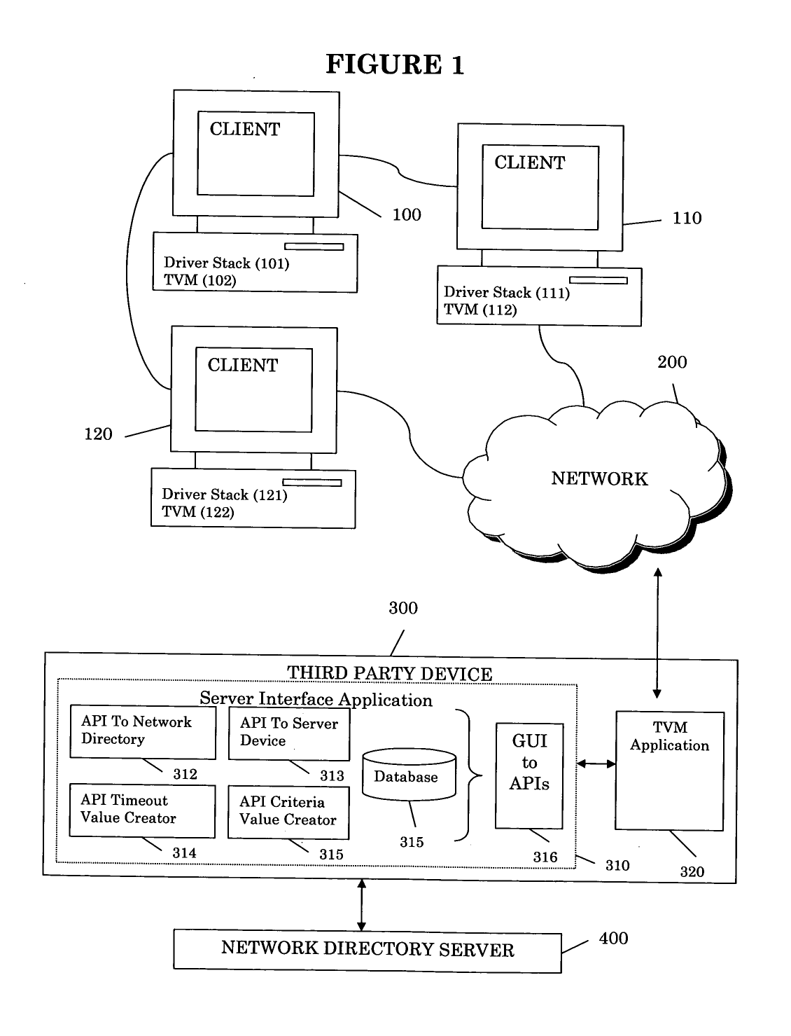

FIG. 1 illustrates an exemplary embodiment of a system in accordance with the present invention. As illustrated, the system may include one or more clients 100, 110, and 120, a network 200, a third party device 300, and a network directory server 400. The client portion 100, 110, and 120, of the system includes drivers (driver stack 101, 111, and 121) and a communication application referred to as a Transport Virtualization Module (TVM) application 102, 112, and 122, respectively. The client application may be resident on a plurality of endpoint devices on a network or virtual network that a network administrator wishes to control.

Through the network 200, the clients 100, 110, and 120 are connected to the third party device 300. The third party device 300 may comprise a file server, a content matching system, an Intrusion Detection System/Intrusion Prevention System (IDS/IPS system), a network attached storage (NAS) system, or any other purpose-driven network attached appliance. Resident on the third party device 300 are a Server Interface Application 310 and a TVM application 320. As illustrated in FIG. 1, the third party device 300 may interface with a Network Directory Server 400 for additional functionality. Examples of Network Directory Servers include Microsoft's activeDirectory, Novell's eDirectory, etc.

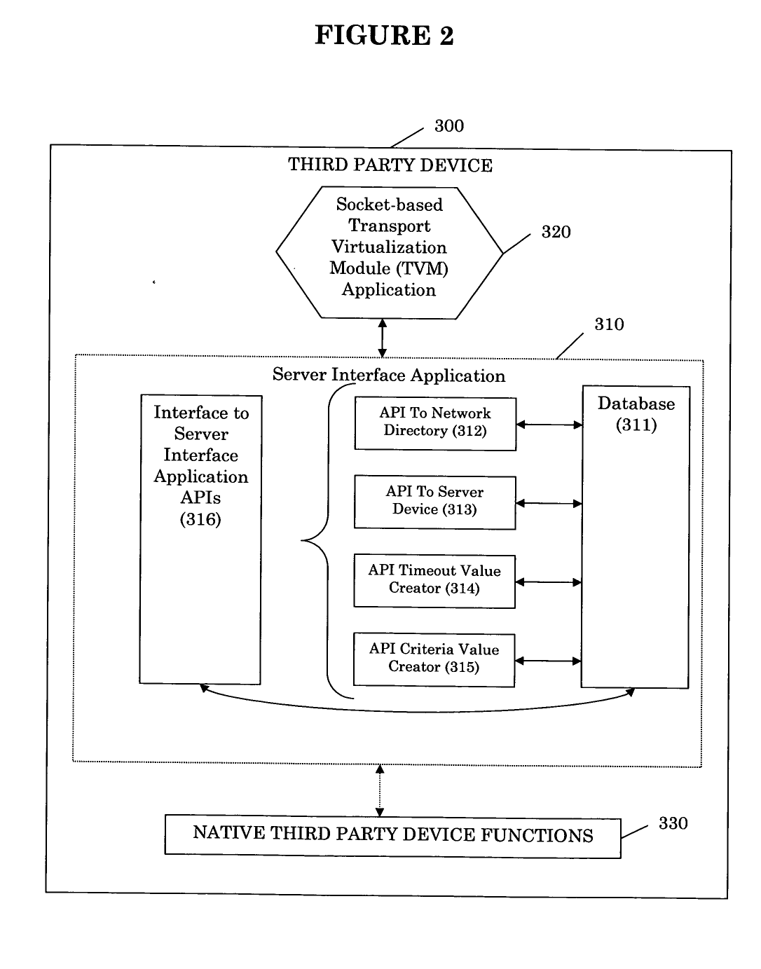

FIG. 2 illustrates an exemplary third party device in accordance with the present invention. Included in the illustrated third party device 300 is a socket-based TVM application 320, a Server Interface Application 310, and native third party device functions 330. The TVM application 320 provides for communication with clients over the network.

The Server Interface Application 310 includes a database 311, an application programming interface (API) to Network Directory 312, an API to Server Device 313, an API Timeout Value Creator 314, an API Criteria Value Creator 315, and an Interface to Server Interface Application APIs 316. The API to Server Device 313 may be a custom API that allows clients to send identification information to the third party device 300 and receive information and instructions when the third party device 300 interacts with client information. For example, when a client sends information to the third party device 300 for validation of write authority, there may be information in a header indicating that authorization authority should be sent to the API to Server Device 313. Thus, the information can be forwarded to the TVM application 320 and communicated back to the client via TVM application 320.

The API to Network Directory 312 allows information to be pulled from the network's directory system to create specific knowledge about the network and policies. The API Timeout Value Creator 314 is a system that allows a user to set timeout values or criteria for each device or groups of devices on the network. The API Criteria Value Creator 314 allows the user to create criteria values for each device or groups of devices on the network.

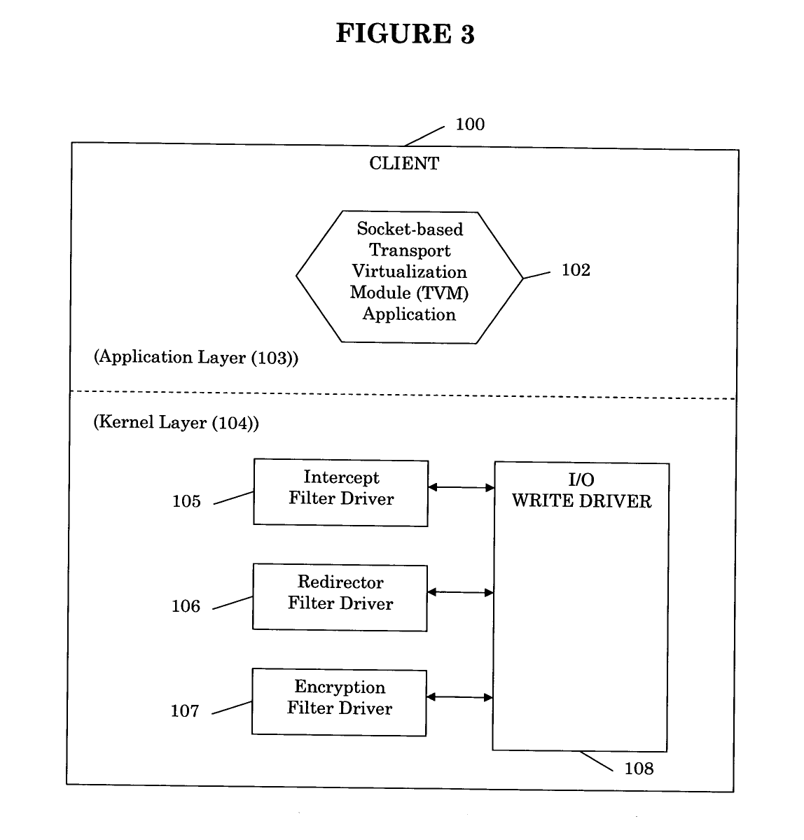

FIG. 3 illustrates an exemplary embodiment of a client in accordance with the present invention. As illustrated in FIG. 3, the client 100 has an application layer 103 and a kernel layer 104. The TVM application 102 resides in the application layer 103. The TVM application 102 is responsible for communicating to and from the client 100 with the third party device 300 and the plurality of APIs of the Server Interface Application 310. The kernel layer 104 of the client includes an Intercept Filter Driver 105, a Redirector Filter Driver 106, and an Encryption Filter Driver 107. The three filter drivers interact with an I/O Write Driver 108, based upon a criteria file and a response system through the TVM application 102 in the application layer 103, as described in more detail below.

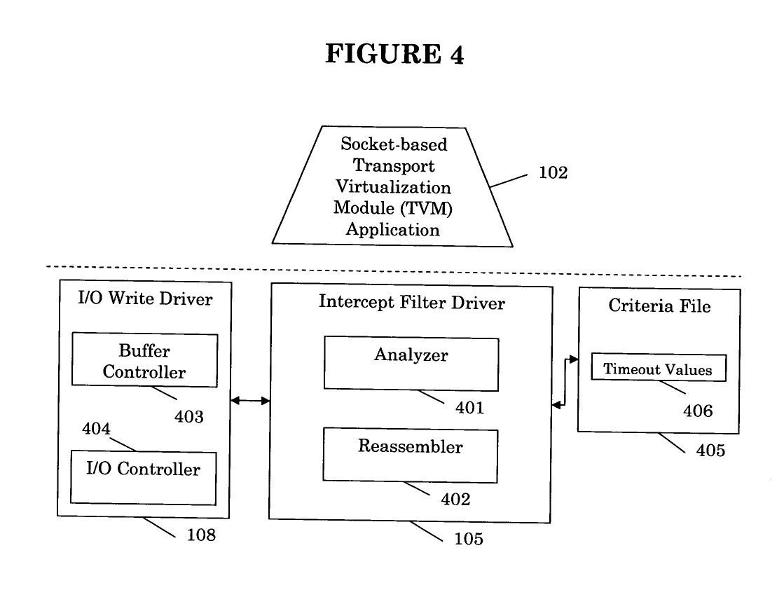

FIG. 4 illustrates an exemplary embodiment of an Intercept Filter Driver 105 in accordance with the present invention. The Intercept Filter Driver 105 may include an Analyzer 401 and a Reassembler 402. As illustrated in FIG. 4, the I/O Write Driver 108 may include a Buffer Controller 403 for controlling how data is buffered during processing and an I/O Controller 404 for sending calls, e.g., write, commit, rollback, etc. The Intercept Filter Driver 105 is a part of the client's kernel layer driver stack, which interacts with the Criteria File 405 to obtain values “of interest,” i.e., values that match predetermined criteria. These values may include Timeout Values 406, for example, which allow the Intercept Filter Driver 105 to quickly look at all files being written. The Analyzer 401 may determine whether the files are “of interest.” If the files do not match the criteria, they are reassembled using the Reassembler 402 and passed back to the native I/O write process of the operating system. Conversely, if the files match one or more of the criteria, the files are sent to the Redirector Filter Driver 106 (described below) for further processing or they are rolled back and cleaned up, i.e., an operating system rollback process, depending upon the policies established by the network administrator.

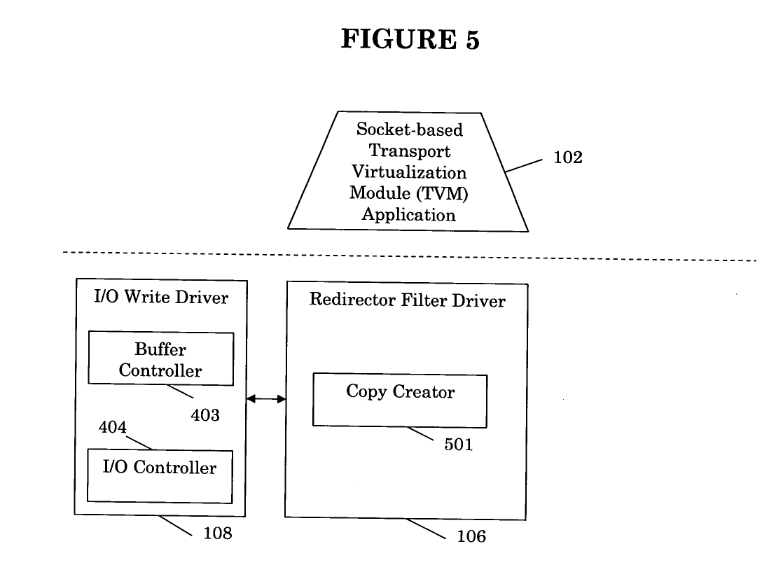

FIG. 5 illustrates an exemplary embodiment of a Redirector Filter Driver in accordance with the present invention. The Redirector Filter Driver 106 creates a complete or partial copy of the file with a Copy Creator 501, depending upon the values of the criteria file that were passed from the Intercept Filter Driver 105. Using the TVM application 102, the Redirector Filter Driver 106 sends a copy to the third party device 300 and waits for a response from the TVM application 102 regarding further processing of the file.

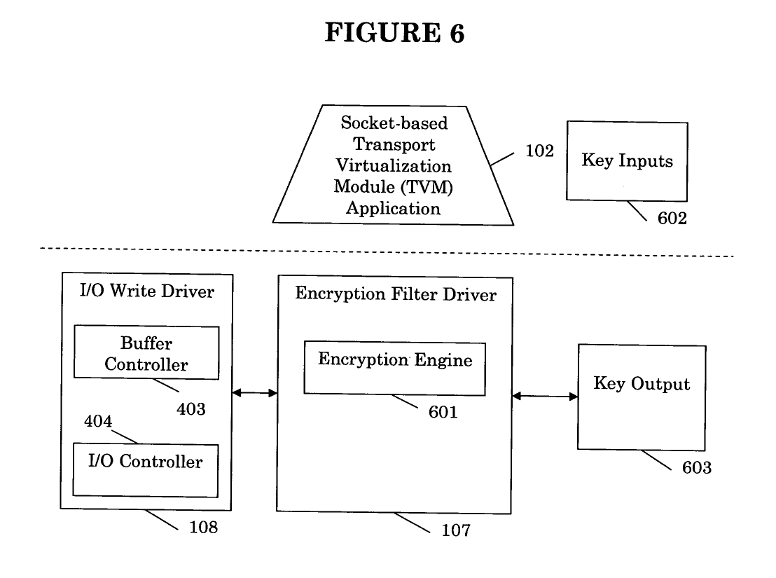

FIG. 6 illustrates an exemplary embodiment of an Encryption Filter Driver in accordance with the present invention. Based upon the response from the third party device 300 and the inputs of the criteria file, the file may be encrypted when it is written. That is, an Encryption Engine 601 may interface with the operating system I/O write process and encrypt the file. The Encryption Engine 601 may use inputs (e.g., Key Inputs 602) from the application layer of the device on which it is resident and output a Key Output 603 that can be used to decrypt the file.

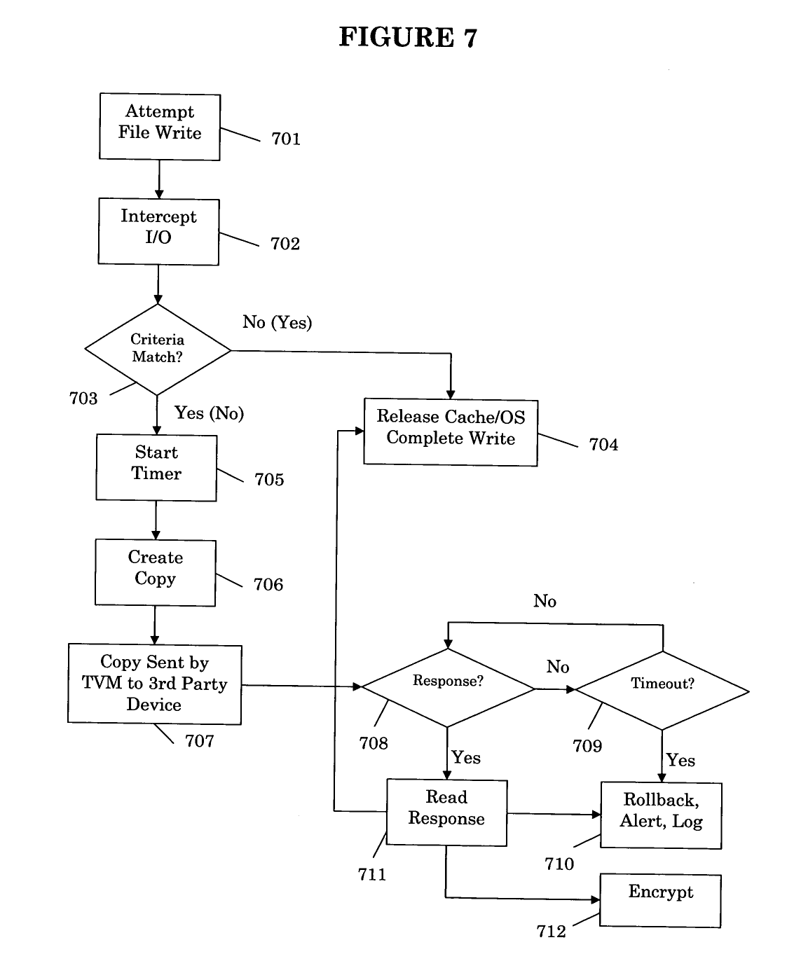

FIG. 7 illustrates an exemplary embodiment of a method for controlling file writing in accordance with the present invention. In step 701, a client attempts to write a file, e.g., any file that is written using the operating system I/O write control of the client. According to this embodiment, the file to be written may be placed in a cache, where it will be held until a command to either release the cache and write the file or to clear the cache is given. Once the write process begins, an Interceptor Filter Driver in the client is awakened by the I/O write process and intercepts the write information associated with the file write process in step 702. The Interceptor Filter Driver, in step 703, evaluates the I/O write information to determine if any of the criteria from a criteria file are matched. If the criteria are not matched, the write process is released to the cache/operating system process in step 704 and the write process is completed. In an alternative embodiment, indicated by “(Yes)” and “(No)” in FIG. 7, when there is a match of the predetermined criteria, the write process is completed. This could be done if a network was set up to write all files that meet the criteria and prevent all other files from writing.

If the criteria from the criteria file are matched, a timer is started in step 705 and the I/O process is handed to the Redirector Filter Driver 106 (FIG. 5), which creates a copy of the file in step 706 and sends the copy to a third party device in step 707 using the TVM application. The copy may be a full copy or a partial copy, depending upon the criteria match. Then the client waits for a response from the third party device in step 708. If a response is not received within a predetermined period of time, a timeout value is checked in step 709. If the timeout value has not been reached, the client continues to wait for a response step 708. If the timeout value is reached, the write process is not allowed and a rollback process is initiated to undo any changes made by the write process in step 710. A notification may be sent to the client to inform a user of the write failure, and a log file may be created to keep a log of write failures in the network in step 710.

If a response is received, the response is read in step 711. Depending upon the response, the following actions may occur: (1) release the write process of the operating system and allow the file write to complete unhindered in step 704, (2) prevent the write process from completing and initiate a rollback process, alert the user to the write failure, and create a log file in step 710, or (3) encrypt the file during the write process in step 712.

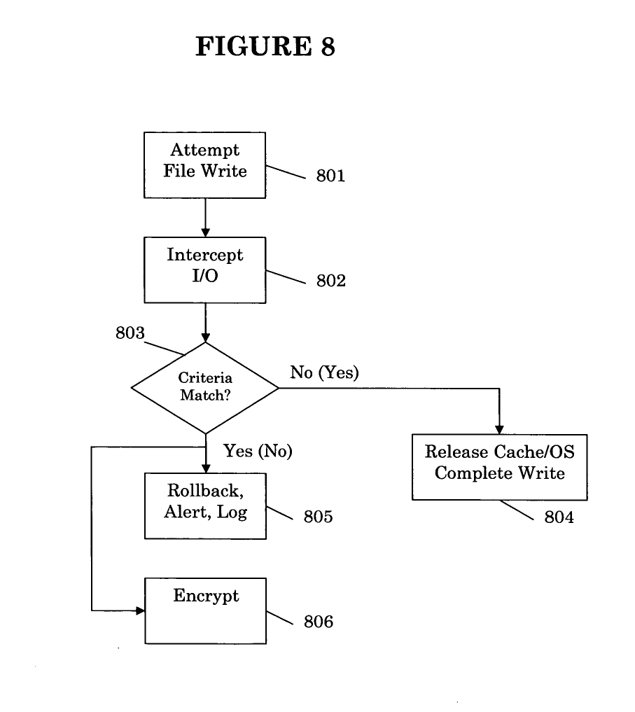

FIG. 8 illustrates an exemplary embodiment of another method for controlling file writing in accordance with the present invention. At the beginning of a write process, a client attempts to write a file in step 801, i.e., sends a file for processing to be written. The file may be any file that is written using the operating system I/O write control of the client. An Interceptor Filter Driver in the client is awakened by the I/O write process and in step 802 intercepts the write information associated with the file write process. In step 803, the Interceptor Filter Driver evaluates the I/O write information to determine if any of the criteria from a criteria file are matched. If the criteria are not matched, the write process is released to the cache/operating system process and the write process is completed in step 804.

In FIG. 8, if the criteria from the criteria file are matched and the criteria indicate that writing the file is unacceptable, the write process is not allowed to complete and a rollback process is initiated to undo any changes made by the write process in step 805. Additionally, in step 805, a write failure notification may be sent to the client to inform the user of the failed attempt to write the file, and a log file may be created to keep a record of file write failures. Alternatively, if the criteria are matched, but the criteria do not indicate that writing the file is unacceptable, in step 806 the file may be encrypted during the write process. In this embodiment of the present invention, the file does not need to be sent to the third party device for further processing. For example, if a system administrator implements criteria that no files are to be written during a certain time period, and a user attempts to write a file during that time period, the criteria matching in the client would determine that the file is not allowed to be written. Thus, no further processing by the third party device would be needed.

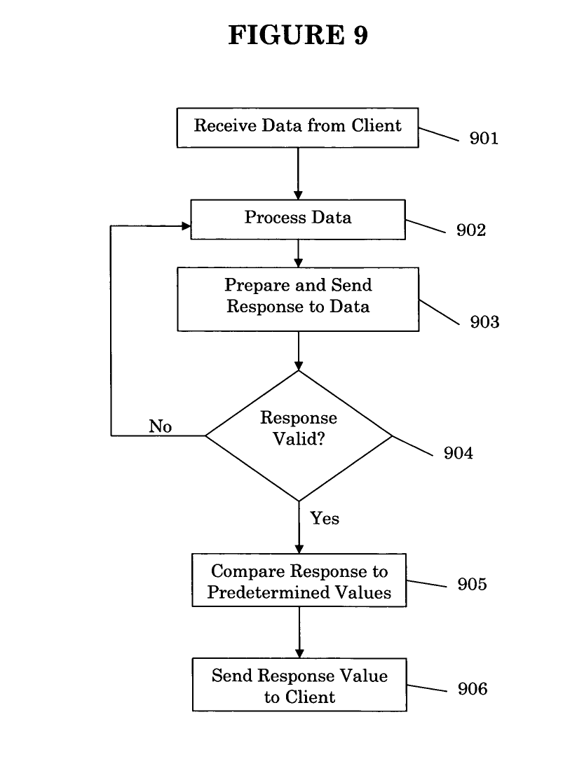

FIG. 9 illustrates an exemplary embodiment of a method for interacting with a client by a third party device, in accordance with the present invention. In step 901, a third party device receives data from a client, e.g., a copy of a file to be written. In an exemplary embodiment of the method, the data is transmitted using a TCP/IP protocol. The third party device processes the data in step 902. For example, the third party device may determine whether a copy of a file matches any predetermined criteria. Based on this processing, the third party device prepares a response and sends it to a resident API, e.g., the API of the Server Device, in step 903. A determination is made in step 904 of whether the response is valid. If the response is not valid, the data is sent back (to step 902) for further processing by the third party device.

If the response is valid, in step 905 the response is compared to predetermined values, which may be stored in a database. These predetermined values may be values established by a network administrator. In step 906, a response value is sent to the client. As described above, the communication between the third party device and the client may be done through a communication application resident on each, e.g., a Transport Virtualization Module application.

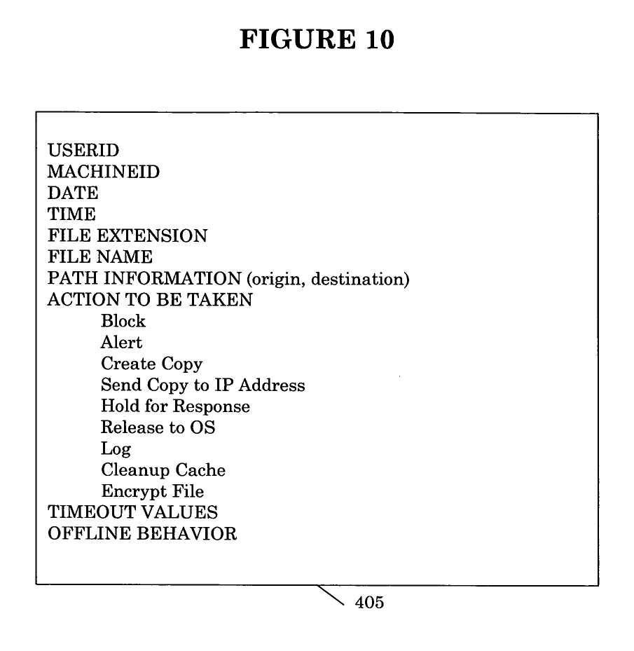

FIG. 10 illustrates an exemplary embodiment of a criteria file in accordance with the present invention. The criteria file 405 may be stored in the endpoint to limit network traffic in a system requiring large amounts of data to traverse a network. The criteria file stored in the endpoint may contain a first level of authorization for file writing in the endpoint. As illustrated in FIG. 10, the criteria file may include, for example, general write authorities, user ID, machine ID, date, time, file extension, file name, path information, action to be taken, timeout values, and offline behavior. The criteria may be used to compare to information in a file write process to determine whether to allow the file write to occur, as described above. The actions to be taken that are illustrated in FIG. 10 may include blocking the file from writing, sending an alert to a client, creating a copy of the file, sending a copy of the file to an IP address, holding the file write for a response, releasing the file write to the operating system, logging a file write failure, cleaning a cache, and encrypting a file. These actions are merely exemplary, as other actions may occur as well.

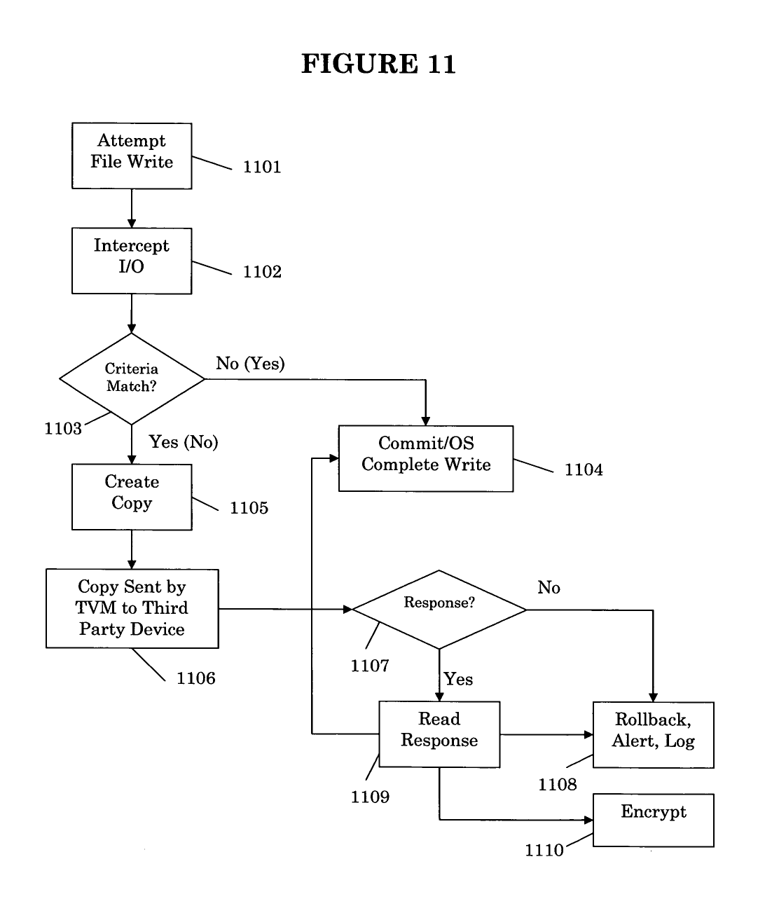

FIG. 11 illustrates an exemplary embodiment of a method for controlling writing of files, in accordance with the present invention. In step 1101, a client attempts to write a file, i.e., any file that is written using the operating system I/O write control of the client. According to this embodiment, a copy of the path data of the file is sent to a cache and the file is sent to its end destination, but the writing of the file is held until a “commit” command is issued. Once the write process begins, an Interceptor Filter Driver in the client is awakened by the I/O write process and intercepts the write information associated with the file write process in step 1102.

The Interceptor Filter Driver evaluates the I/O write information in step 1103 to determine if any of the criteria from a criteria file are matched. If the criteria are not matched, the write is committed, i.e., a “commit” command is issued, and the write process is completed by an operating system in step 1104. In an alternative embodiment, indicated by “(Yes)” and “(No)” in FIG. 11, when there is a match of the predetermined criteria, the write process is completed. This could be done if a network is set up to write all files that meet the criteria and prevent all other files from writing.

If the criteria from the criteria file are matched, a copy of the file is created in step 1105 and sent to a third party device in step 1106 using the TVM application. If there is a criteria match, the I/O process may be handed to a Redirector Filter Driver (FIG. 5), which creates the copy of the file. The copy may be a full copy or a partial copy, depending upon the criteria match. Then the client waits for a response from the third party device in step 1107. If a response is not received, the write process is not allowed and a rollback process is initiated in step 1108 to undo any changes made by the write process. A notification may be sent to the client to inform a user of the write failure, and a log file may be created to keep a log of write failures in the network in step 1108.

If a response is received, the response is read in step 1109. Depending upon the response, the following actions may occur: (1) release the write process of the operating system and allow the file write to complete unhindered in step 1104, (for example by issuing a commit command), (2) prevent the write process from completing and initiate a rollback process, which may further include alerting the user to the write failure and creating a log file, in step 1108, or (3) resend the write request and encrypt the file during the write process in step 1110.

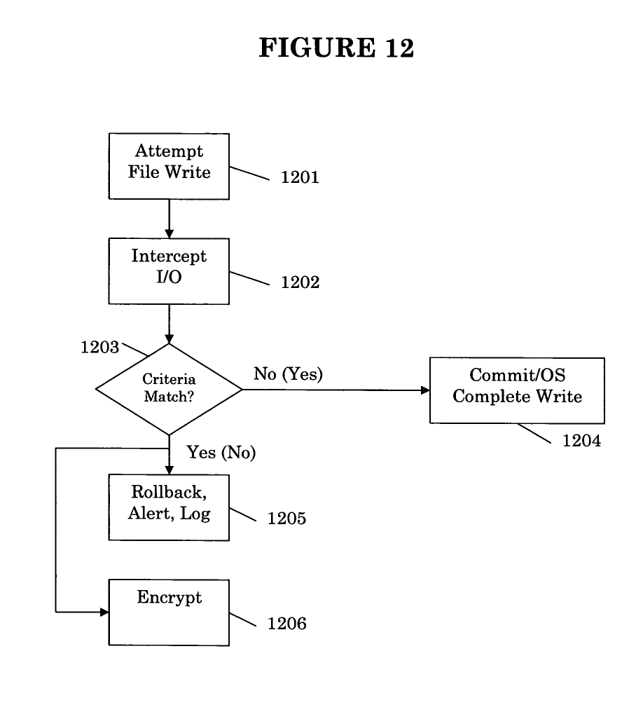

FIG. 12 illustrates another exemplary embodiment of a method for controlling writing of files, in accordance with the present invention. At the beginning of a write process, a client attempts to write a file in step 1201, i.e., sends a file write request for processing the file to be written. The file may be any file that is written using the operating system I/O write control of the client. An Interceptor Filter Driver in the client is awakened by the I/O write process and in step 1202 intercepts the write information associated with the file write process. In step 1203, the Interceptor Filter Driver evaluates the I/O write information to determine if any of the criteria from a criteria file are matched. If the criteria are not matched, the write process is released to the operating system and the write process is completed in step 1204 by issuing a commit command.

In FIG. 12, if the criteria from the criteria file are matched and the criteria indicate that writing the file is unacceptable, the write process is not allowed to complete and a rollback process is initiated to undo any changes made by the write process in step 1205. Additionally, in step 1205, a write failure notification may be sent to the client to inform the user of the failed attempt to write the file, and a log file may be created to keep a record of file write failures. Alternatively, if the criteria are matched, but the criteria do not indicate that writing the file is unacceptable, the write request is resent and the file may be encrypted during the write process in step 1206. In this embodiment of the present invention, the file does not need to be sent to the third party device for further processing, because the client itself determines that the file is not to be written.

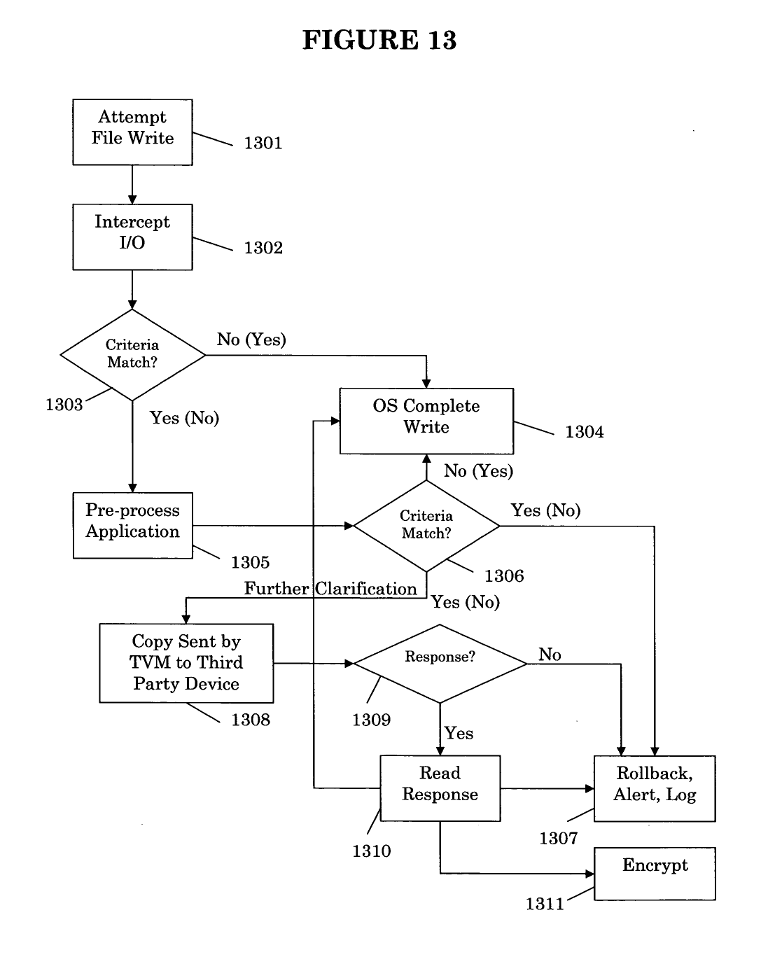

FIG. 13 illustrates an exemplary embodiment of a method for controlling writing of files using a pre-processing application, in accordance with the present invention. In step 1301, a client attempts to write a file, i.e., any file that is written using the operating system I/O write control of the client. Once the write process begins, an Interceptor Filter Driver in the client is awakened by the I/O write process and intercepts the file write request associated with the file write process in step 1302.

The Interceptor Filter Driver evaluates the I/O write information in step 1303 to determine if any of the criteria from a criteria file are matched. If the criteria are not matched, the write process is released to an operating system for write completion in step 1304. In an alternative embodiment, indicated by “(Yes)” and “(No)” in FIG. 13, when there is a match of the predetermined criteria, the write process is completed. This could be done if a network is set up to write all files that meet the criteria and prevent all other files from writing.

If the criteria from the criteria file are matched, a copy of the file is created and sent to a pre-process application in step 1305. The pre-processing application may include a subset of the functionality of a third party device described above. A pre-process API may be used to load the data used by the pre-process application.

In step 1306, it is determined by the pre-process application whether there is a criteria match between the file write request and any of predetermined criteria. If there is no criteria match, the write process is released to the operating system for write completion in step 1304. If there is a criteria match indicating that the write process is not acceptable, the write process is not allowed and a rollback process is initiated in step 1307 to undo any changes made by the write process. Also, a notification may be sent to the client to inform a user of the write failure, and a log file may be created to keep a log of write failures in the network in step 1307. If there is a criteria match indicating that the write process may be acceptable, but it is determined, based upon the criteria matching, that further clarification or evaluation of the file write request is needed, a copy of the file is sent to the third party device in step 1308 for further processing.

If a response is received from the third party device, which is determined in step 1309, the response is read in step 1310. If no response is received, the write process is prevented from completing and a rollback process is initiated in step 1307, which may further include alerting the client to the write failure and creating a log file of the write failure. Depending upon a received response, the following actions may occur: (1) release the write process to the operating system and allow the file write to complete unhindered in step 1304, (2) prevent the write process from completing and initiate a rollback process, which may further include alerting the user to the write failure and creating a log file, in step 1307, or (3) resend the write request and encrypt the file during the write process in step 1311.

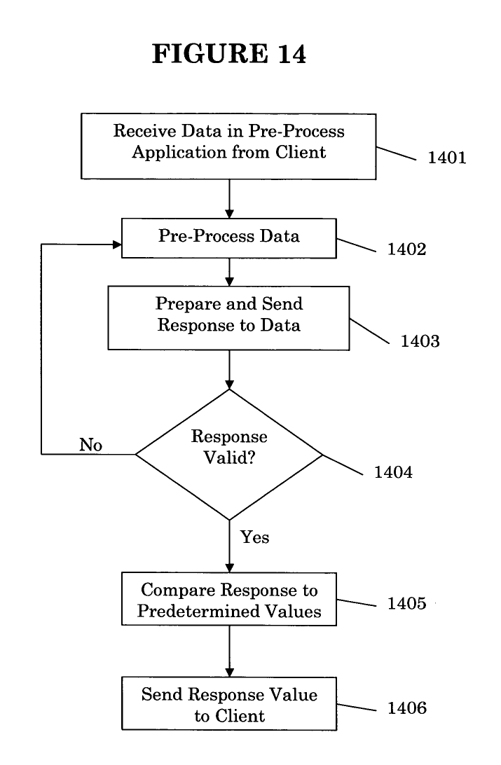

FIG. 14 illustrates another exemplary embodiment of a method for controlling writing of files using a pre-process application, in accordance with the present invention. In step 1401, a pre-process application receives data from a client, e.g., a write request for a file to be written. The pre-process application processes the data in step 1402. For example, the pre-process application may determine whether a file write request matches any predetermined criteria. Based on this processing, the pre-process application prepares a response and sends it to the API of the Interceptor Driver of the client, in step 1403. A determination is made in step 1404 of whether the response is valid. If the response is not valid, the data is sent back (to step 1402) for further processing by the pre-process application.

If the response is valid, in step 1405 the response is compared to predetermined values, which may be stored in a database. The predetermined values may be values established by a network administrator. In step 1406, a response value may be sent to the Interceptor Driver, which may intercept the file write request and determine whether there is a criteria match with predetermined criteria to determine whether to release the write request to the operating system to complete the file write.

In another exemplary embodiment of the present invention, there is a computer-readable medium encoded with a computer program for controlling file writing in a network. The term “computer-readable medium” as used herein refers to any medium that participates in providing instructions for execution. Such a medium may take many forms, including but not limited to, non-volatile media, volatile media, and transmission media. Non-volatile media includes, for example, optical or magnetic disks. Volatile media includes, for example, dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave, or any other medium from which a computer can read.

Exemplary embodiments of a computer-readable medium encoded with a computer program for controlling file writing in a network are illustrated in FIGS. 7-9 and 11-14, which are described above.

While the invention has been described in connection with various embodiments, it will be understood that the invention is capable of further modifications. This application is intended to cover any variations, uses or adaptation of the invention following, in general, the principles of the invention, and including such departures from the present disclosure as, within the known and customary practice within the art to which the invention pertains.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling file writing in a network, comprising the acts of:
intercepting a request to write a file at an endpoint of the network;
comparing the file write request to predetermined criteria;
allowing completion of the file write request, if the file write request does not match any of the predetermined criteria; and
creating a copy of the file, transmitting the copy to a third party device, and at least temporarily preventing completion of the file write request, if the file write request matches any of the predetermined criteria.

2. The method of claim 1, further comprising the act of:
determining whether the file writing may continue, based upon the matching predetermined criteria.

3. The method of claim 2, further comprising the act of:
encrypting the file during the file writing.

4. The method of claim 2, further comprising the act of:
initiating a rollback process.

5. The method of claim 2, further comprising the act of:
sending a file write failure notification to a user.

6. The method of claim 2, further comprising the act of:
creating a file write failure log.

7. The method of claim 1, wherein allowing completion of the file write request comprises releasing the file write request from a cache to an operating system.

8. The method of claim 1, further comprising the acts of:
determining whether a response is received by the client from the third party device prior to reaching a timeout value; and
preventing completion of the file write request and initiating a rollback process, if the timeout value is reached.

9. The method of claim 8, further comprising the act of:
sending a file write failure notification to a user.

10. The method of claim 9, further comprising the act of:
creating a file write failure log.

11. The method of claim 1, further comprising the act of:
pre-processing the file write request prior to transmitting the copy of the file to the third party device.

12. The method of claim 1, wherein allowing completion of the file write request comprises issuing a commit command to an operating system.

13. A system for controlling writing of a file in a network, comprising:
an endpoint device including a client configured to intercept a file write request from the endpoint device, compare the request to predetermined criteria, and make and output a copy of the file if the request matches any of the predetermined criteria; and
a third party device configured to receive the copy via the network, evaluate the copy based upon the predetermined criteria, and control the file write request based upon a result of the evaluation.

14. The system of claim 13, further comprising a network directory server that interfaces with the third party device.

15. The system of claim 13, wherein the control of the file write request comprises one of allowing the file write request to complete, preventing the file write request from completing, and encrypting the file during the file writing.

16. The system of claim 15, wherein preventing the file write request from completing comprises initiating a rollback process.

17. The system of claim 16, wherein preventing the file write request from completing further comprises informing a user of a file write failure.

18. The system of claim 17, wherein preventing the file write request from completing further comprises creating a log file of the file write failure.

19. The system of claim 13, wherein the client comprises an intercept filter driver which intercepts the request and compares the request to the predetermined criteria, a redirector filter driver which creates and outputs the copy of the request, and an encryption filter driver which encrypts the file during the file writing if instructed to perform an encryption.

20. The system of claim 13, wherein the third party device comprises a communication portion and a server interface portion.

21. A computer-readable medium encoded with a computer program for controlling file writing in a network, the computer program comprising instructions for:
intercepting a request to write a file at an endpoint of the network;
comparing the file write request to predetermined criteria;
allowing completion of the file write request, if the file write request does not match any of the predetermined criteria; and
creating a copy of the file, transmitting the copy to a third party device, and at least temporarily preventing completion of the file write request, if the file write request matches any of the predetermined criteria.

22. The computer-readable medium of claim 21, the computer program further comprising instructions for:
determining whether the file writing may continue, based upon the matching predetermined criteria.

23. The computer-readable medium of claim 22, the computer program further comprising instructions for:
encrypting the file during the file writing.

24. The computer-readable medium of claim 22, the computer program further comprising instructions for:
initiating a rollback process.

25. The computer-readable medium of claim 22, the computer program further comprising instructions for:
sending a file write failure notification to a user

26. The computer-readable medium of claim 22, the computer program further comprising instructions for:
creating a file write failure log.

27. The computer-readable medium of claim 21, wherein allowing completion of the file write request comprises releasing the file write request to an operating system.

28. The computer-readable medium of claim 21, the computer program further comprising instructions for:
determining whether a response is received by the client from the third party device prior to reaching a timeout value; and
preventing completion of the file write request and initiating a rollback process, if the timeout value is reached.

29. The computer-readable medium of claim 28, the computer program further comprising instructions for:
sending a file write failure notification to a user.

30. The computer-readable medium of claim 29, the computer program further comprising instructions for:
creating a file write failure log.

31. The computer-readable medium of claim 21, the computer program further comprising instructions for:
pre-processing the file write request prior to transmitting the copy of the file to the third party device.

32. The computer-readable medium of claim 21, wherein allowing completion of the file write request comprises issuing a commit command to an operating system.

33. A method for controlling file writing in a network, comprising the acts of:
intercepting a request to write a file at an endpoint of the network;
comparing the file write request to predetermined criteria;
allowing completion of the file write request, if the file write request matches any of the predetermined criteria; and
creating a copy of the file, transmitting the copy to a third party device, and at least temporarily preventing completion of the file write request, if the file write request does not match any of the predetermined criteria.
